(19) United States
(12) Patent Application Publication
(10) Pub. No.: US 2019/0317421 A1
(43) Pub. Date: Oct. 17, 2019

(54) EMULSION AGGREGATION TONER COMPRISING BRANCHED WAX

(71) Applicant: Xerox Corporation, Norwalk, CT (US)

(72) Inventors: Varun Sambhy, Pittsford, NY (US); Alexander N. Klymachyov, Webster, NY (US); Padam K. Angra, Pittsford, NY (US); Santokh S. Badesha, Pittsford, NY (US); Jacob W. Myers, II, Rochester, NY (US); Dennis A. Mattison, JR., Marion, NY (US)

(21) Appl. No.: 15/952,770

(22) Filed: Apr. 13, 2018

(51) Int. Cl. G03G 9/093; G03G 9/087; G03G 15/08

(52) U.S. Cl. CPC G03G 9/09378; G03G 9/09328; G03G 2215/0607; G03G 15/0865; G03G 9/08755

(57) ABSTRACT

An emulsion aggregation (EA) toner particle for use in a xerographic apparatus having an oiled fusing system, the EA toner particle including a core including a resin, a branched ester wax having substantially no solubility in fuser oil, a coagulant, and an optional colorant. Such toners may be part of a toner composition and are useful in printing procedures such as image-on-image printing.

### BACKGROUND

The present disclosure relates to xerography. In particular, the present disclosure relates to toners employed in xerographic systems having oiled fusing systems.

Various xerographic systems employ an oiled fusing system in which the fuser roll and belt substrates are treated with fuser oil to impart release properties. It has been observed that toners containing hydrocarbon based waxes suffer from wax dissolution in the hot fuser oil and subsequently forms a gel when the oil cools in the sump. The gel can then clog and contaminate the system leading to performance problems. Thus, such systems generally require a “waxless” toner design.

However, waxless toners fail to adequately release when low amounts of fuser oil on the prints is desired for certain applications (e.g., multi-pass fusing, post-fusing processing, etc.). The present disclosure addresses these issues by providing a new emulsion aggregation (EA) toner comprising branched ester waxes for use in oiled fusing systems at low and high fuser oil rates. The EA toner disclosed herein provides the release benefits from the presence of wax while exhibiting substantially no solubility in fuser oil. These and other advantages will be apparent to the skilled artisan.

### SUMMARY

In some aspects, embodiments relate to emulsion aggregation (EA) toner particles for use in a xerographic apparatus comprising an oiled fusing system, the EA toner particle comprising a core comprising a resin, a branched ester wax having substantially no solubility in fuser oil, a coagulant, and an optional colorant.

In some aspects, embodiments relate to toner compositions comprising an emulsion aggregation (EA) toner particle for use in a xerographic apparatus comprising an oiled fusing system, the EA toner particle comprising a core comprising a resin, a branched ester wax having substantially no solubility in fuser oil, a coagulant, and an optional colorant, and a shell, and surface additives disposed on the surface of the EA toner particle.

In some aspects, embodiments relate to methods of printing comprising providing a toner composition in a toner cartridge, the toner composition comprising an emulsion aggregation (EA) toner particle for use in a xerographic apparatus comprising an oiled fusing system, the EA toner particle comprising a core comprising a resin, a branched ester wax having substantially no solubility in fuser oil, a coagulant, and an optional colorant, and a shell, and surface additives disposed on the surface of the EA toner particle.

### BRIEF DESCRIPTION OF DRAWINGS

Various embodiments of the present disclosure will be described herein below with reference to the figures wherein:

FIG. 1 shows a schematic of a typical electrostatic reproducing apparatus.

FIG. 2a shows a differential scanning calorimetry (DSC) plot of (1) the branched ester wax alone; (2) an EA toner comprising a branched wax ester; (3) a waxless EA toner; and (4) an EA toner comprising a hydrocarbon based wax.

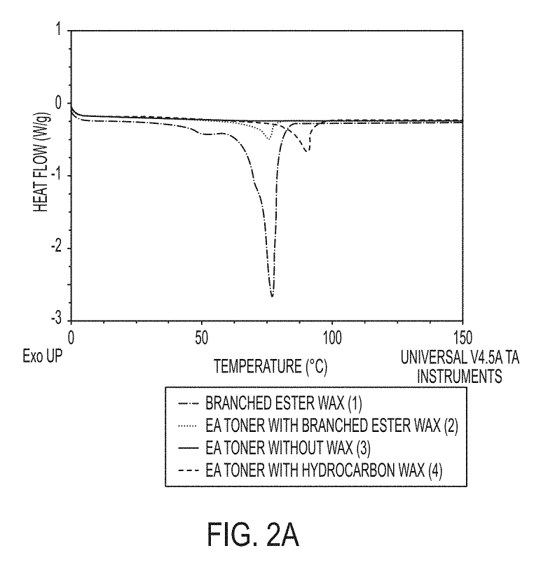

FIG. 2b shows another DSC plot of (1) the branched ester wax alone; (2) an EA toner comprising a branched wax ester; (3) a waxless EA toner; (4) an EA toner comprising a hydrocarbon based wax; and (5) the hydrocarbon wax alone.

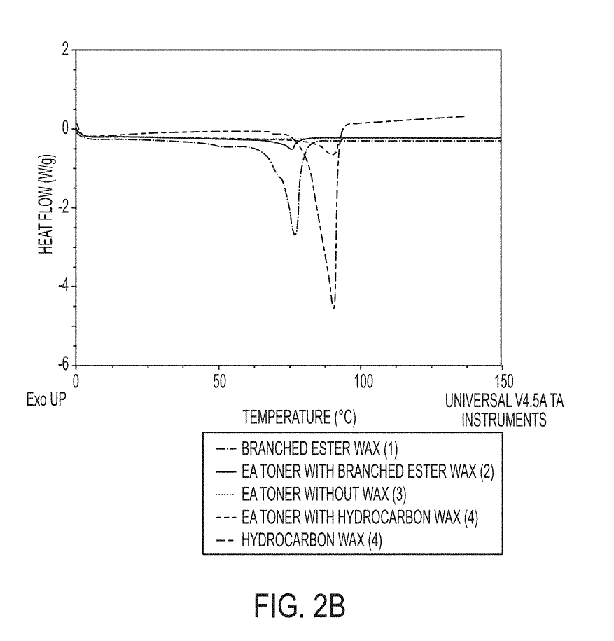

FIG. 3 shows a transmission electron microscope (TEM) image of an EA toner comprising a branched ester wax in accordance with embodiments herein.

### DETAILED DESCRIPTION

Embodiments herein provide emulsion aggregation (EA) toner particles for use in a xerographic apparatus comprising an oiled fusing system. The EA toner particle comprises a core comprising (1) a resin; (2) a branched ester wax having substantially no solubility in fuser oil; (3) a coagulant; and (4) an optional colorant. The use of the branched ester wax in the toner formulation provides control of the functional properties like toner rheology-melt/fix temperature and may allow the fuser to operate with low oil levels facilitating good toner to toner adhesion in multi-pass print mode. Good multi-pass print mode performance especially toner to toner adhesion allows for implementation of specialty toners like white, gold, silver, and clear, for example. The branched wax esters disclosed herein are substantially insoluble in fuser oil, thus obviating the typical problem associated with incorporating a wax into toner particles when used in oiled fusing systems.

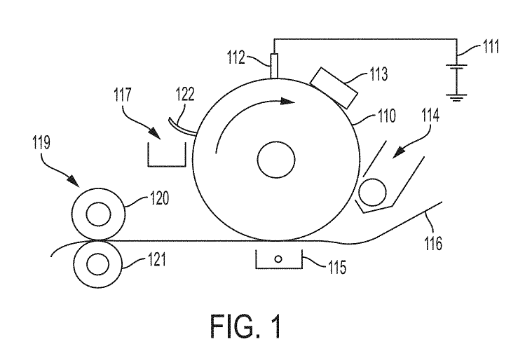

As used herein, “oiled fusing system” refers to a release material used in connection with an electrostatic reproducing apparatus. Referring to FIG. 1, in a typical electrostatic reproducing apparatus, a light image of an original to be copied is recorded in the form of an electrostatic latent image upon a photosensitive member and the latent image is subsequently rendered visible by the application of electroscopic thermoplastic resin particles which are commonly referred to as toner. Specifically, photoreceptor 110 is charged on its surface by means of a charger 112 to which a voltage has been supplied from power supply 111. The photoreceptor 110 is then imagewise exposed to light from an optical system or an image input apparatus 113, such as a laser and light emitting diode, to form an electrostatic latent image on the photoreceptor 110. Generally, the electrostatic latent image is developed by bringing a developer mixture from developer station 114 into contact herewith. Development can be effected by use of a magnetic brush, powder cloud, or other known development process. A dry developer mixture usually comprises carrier granules having toner particles adhering triboelectrically thereto. Toner particles are attracted from the carrier granules to the latent image forming a toner powder image. Alternatively, a liquid developer material may be employed, which includes a liquid carrier having toner particles dispersed therein. The liquid developer material is advanced into contact with the electrostatic latent image and the toner particles are deposited thereon in image configuration.

After the toner particles have been deposited on the photoconductive surface, in image configuration, they are transferred to a copy sheet 116 by transfer means 115, which can be pressure transfer or electrostatic transfer. Alternatively, the developed image can be transferred to an intermediate transfer member, or bias transfer member, and subsequently transferred to a copy sheet. Examples of copy substrates include paper, transparency material such as polyester, polycarbonate, or the like, cloth, wood, or any other desired material upon which the finished image will be situated.

After the transfer of the developed image is completed, copy sheet 116 advances to fusing station 119, depicted in FIG. 1 as fuser roll 120 and pressure roll 121 (although any other fusing member components such as fuser belt in contact with a pressure roll, fuser roll in contact with pressure belt, and the like, are suitable for use with the present apparatus), where the developed image is fused to copy sheet 116 by passing copy sheet 116 between the fusing and pressure members, thereby forming a permanent image. Alternatively, transfer and fusing can be effected by a transfix application. Photoreceptor 110, subsequent to transfer, advances to cleaning station 117, where any toner left on photoreceptor 110 is cleaned therefrom by use of a blade 122 (as shown in FIG. 1), brush, or other cleaning apparatus. Alternatively, transfer and fusing can be effected by a transfix application.

Fuser oil, also called release fluid, is applied onto the outer layer of the fuser member via a delivery mechanism such as a delivery roll. The delivery roll is partially immersed in a sump, which houses the fuser oil.

The fuser oil is typically renewable in that the fuser oil is housed in a holding sump and provided to the fuser roll when needed, optionally by way of a fuser oil donor roll in an amount of from about 0.1 to about 20 mg/copy, or from about 1 to about 12 mg/copy. The system by which fuser oil is provided to the fuser roll via a holding sump and, optionally, a donor roll is well known. The fuser oil may be present on the fuser member surface in a continuous or semi-continuous phase. The fuser oil in the form of a film is in a continuous phase and continuously covers the fuser member.

As used herein, “substantially no solubility,” when used in reference to the branched ester waxes, means that the solubility of the branched wax ester in fuser oil is sufficiently low to prevent gelation when the two agents are mixed. That is, when the branched ester wax and fuser oil are mixed, the wax component does not have sufficient solubility to cause gelation as demonstrated further below in Example 2. The actual solubility may be less than about 10%, or less than about 5%, or less than about 1%. However, the suitability of a branched wax ester, which is related to its solubility in fuser oil, is readily assessed merely by the absence of gelation. The actual quantitative solubility need not be determined.

As used herein, “fuser oil” refers to a structure typified by Formula 1 below, though similar and functionally equivalent structures are known:

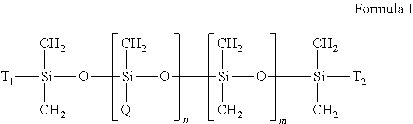

where Q represents —R1-X, wherein R1 represents an alkyl group having from about 1 to about 10 carbons. X represents —NH2 or —NHR2NH2 with R2 having the same description as R1. In Formula I, n is an integer from 1 to 50, m is an integer from 10 to 5,000. T1 and T2 are Q, methyl (—CH3), or hydroxyl (—OH) group or hydride (—H) group. The structure in Formula I can be a block or a random copolymer.

### Resin

In embodiments, the resin comprises a polyester, a styrene-acrylate, or combinations thereof. In embodiments, the polyester is amorphous, crystalline, or combinations thereof. In embodiments, the resin comprises a high molecular weight amorphous polyester (MW range: 60,000 to 80,000), a low molecular weight polyester (MW range: 16,000 to 20,000), and a crystalline polyester. In embodiments, the resin comprises from about 80% to about 99% by weight of the core.

### Styrene-Acrylate Toner

In embodiments, toner particles may be based on styrene-acrylate systems. Exemplary systems include, without limitation, poly(styrene-alkyl acrylate), poly(styrene-alkyl methacrylate), poly(styrene-alkyl acrylate-acrylic acid), poly(styrene-alkyl methacrylate-acrylic acid), poly(alkyl methacrylate-alkyl acrylate), poly(alkyl methacrylate-aryl acrylate), poly(aryl methacrylate-alkyl acrylate), poly(alkyl methacrylate-acrylic acid), poly(styrene-alkyl acrylate-acrylonitrile-acrylic acid), poly(alkyl acrylate-acrylonitrile-acrylic acid), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene), poly(styrene-propyl acrylate), poly(styrene-butyl acrylate), poly(styrene-butyl acrylate-acrylic acid), poly(styrene-butyl acrylate-methacrylic acid), poly(styrene-butyl acrylate-acrylonitrile), poly(styrene-butyl acrylate-acrylonitrile-acrylic acid), poly(styrene-1,3-diene), poly(styrene-1,3-diene-acrylic acid), poly (styrene-1,3-diene-acrylonitrile-acrylic acid), poly(styrene-butadiene), poly(methylstyrene-butadiene), poly (styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), poly(styrene-butyl acrylate-acrylonitrile-acrylic acid), poly(styrene-butadiene), poly(styrene-isoprene), poly(styrene-butyl methacrylate), poly(styrene-butyl methacrylate-acrylic acid), poly(butyl methacrylate-butyl acrylate), poly(butyl methacrylate-acrylic acid), poly(acrylonitrile-butyl acrylate-acrylic acid), and mixtures thereof. The alkyl group in the aforementioned polymers may be any alkyl group, and in particular may be a C₁-C₁₂ alkyl group, for example including methyl, ethyl, propyl and butyl. As the aryl group, any aryl group known in the art may be used.

### Amorphous Polyester Resin

The toner compositions may include core particles comprising an amorphous polyester resin. The amorphous polyester resin may be formed by reacting a diol with a diacid in the presence of an optional catalyst. Examples of diacids or diesters including vinyl diacids or vinyl diesters utilized for the preparation of amorphous polyesters include dicarboxylic acids or diesters such as terephthalic acid, phthalic acid, isophthalic acid, fumaric acid, dimethyl fumarate, dimethyl itaconate, cis, 1,4-diacetoxy-2-butene, diethyl fumarate, diethyl maleate, maleic acid, succinic acid, itaconic acid, succinic acid, succinic anhydride, dodecylsuccinic acid, dodecylsuccinic anhydride, glutaric acid, glutaric anhydride, adipic acid, pimelic acid, suberic acid, azelaic acid, dodecane diacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, and combinations thereof. The organic diacid or diester may be present, for example, in an amount from about 40 to about 60 mole percent of the resin, in embodiments from about 42 to about 52 mole percent of the resin, in embodiments from about 45 to about 50 mole percent of the resin.

Examples of diols which may be utilized in generating the amorphous polyester include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, bis(hydroxyethyl)-bisphenol A, bis(2-hydroxypropyl)-bisphenol A, 1,4-cyclohexanedimethanol, 1,3-cyclohexanedimethanol, xylenedimethanol, cyclohexanediol, diethylene glycol, bis(2-hydroxyethyl) oxide, dipropylene glycol, dibutylene, and combinations thereof. The amount of organic diol selected can vary, and may be present, for example, in an amount from about 40 to about 60 mole percent of the resin, in embodiments from about 42 to about 55 mole percent of the resin, in embodiments from about 45 to about 53 mole percent of the resin.

Polycondensation catalysts which may be utilized in forming either the crystalline or amorphous polyesters include tetraalkyl titanates, dialkyltin oxides such as dibutyltin oxide, tetraalkyltins such as dibutyltin dilaurate, and dialkyltin oxide hydroxides such as butyltin oxide hydroxide, aluminum alkoxides, alkyl zinc, dialkyl zinc, zinc oxide, stannous oxide, or combinations thereof. Such catalysts may be utilized in amounts of, for example, from about 0.01 mole percent to about 5 mole percent based on the starting diacid or diester used to generate the polyester resin. In embodiments, suitable amorphous resins include polyesters, polyamides, polyimides, polyolefins, polyethylene, polybutylene, polyisobutyrate, ethylene-propylene copolymers, ethylene-vinyl acetate copolymers, polypropylene, combinations thereof, and the like. Examples of amorphous resins which may be utilized include alkali sulfonated-polyester resins, branched alkali sulfonated-polyester resins, alkali sulfonated-polyimide resins, and branched alkali sulfonated-polyimide resins. Alkali sulfonated polyester resins may be useful in embodiments, such as the metal or alkali salts of copoly(ethylene-terephthalate)-copoly(ethylene-5-sulfo-isophthalate), copoly(propylene-terephthalate)-copoly(propylene-5-sulfo-isophthalate), copoly(diethylene-terephthalate)-copoly(diethylene-5-sulfo-isophthalate), copoly(propylene-diethylene-terephthalate)-copoly(propylene-diethylene-5-sulfo-isophthalate), copoly(propylene-butylene-terephthalate)-copoly(propylene-butylene-5-sulfo-isophthalate), copoly(propoxylated bisphenol-A-fumarate)-copoly(propoxylated bisphenol A-5-sulfo-isophthalate), copoly(ethoxylated bisphenol-A-fumarate)-copoly(ethoxylated bisphenol-A-5-sulfo-isophthalate), and copoly(ethoxylated bisphenol-A-maleate)-copoly(ethoxylated bisphenol-A-5-sulfo-isophthalate), wherein the alkali metal is, for example, a sodium, lithium or potassium ion.

In embodiments, as noted above, an unsaturated amorphous polyester resin may be utilized as a latex resin. Examples of such resins include those disclosed in U.S. Pat. No. 6,063,827, the disclosure of which is hereby incorporated by reference in its entirety. Exemplary unsaturated amorphous polyester resins include, but are not limited to, poly(propoxylated bisphenol co-fumarate), poly(ethoxylated bisphenol co-fumarate), poly(butyloxylated bisphenol co-fumarate), poly(co-propoxylated bisphenol co-ethoxylated bisphenol co-fumarate), poly(1,2-propylene fumarate), poly(propoxylated bisphenol co-maleate), poly(ethoxylated bisphenol co-maleate), poly(butyloxylated bisphenol co-maleate), poly(co-propoxylated bisphenol co-ethoxylated bisphenol co-maleate), poly(1,2-propylene maleate), poly(propoxylated bisphenol co-itaconate), poly(ethoxylated bisphenol co-itaconate), poly(butyloxylated bisphenol co-itaconate), poly(co-propoxylated bisphenol co-ethoxylated bisphenol co-itaconate), poly(1,2-propylene itaconate), and combinations thereof.

In embodiments, a suitable polyester resin may be an amorphous polyester such as a poly(propoxylated bisphenol A co-fumarate) resin having the following formula (I):

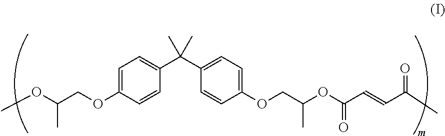

wherein m may be from about 5 to about 1000. Examples of such resins and processes for their production include those disclosed in U.S. Pat. No. 6,063,827, the disclosure of which is hereby incorporated by reference in its entirety.

An example of a linear propoxylated bisphenol A fumarate resin which may be utilized as a latex resin is available under the trade name SPARII from Resana S/A Industrias Quimicas, Sao Paulo Brazil. Other propoxylated bisphenol A fumarate resins that may be utilized and are commercially available include GTUF and FPESL-2 from Kao Corporation, Japan, and EM181635 from Reichhold, Research Triangle Park, N.C., and the like.

In embodiments, the resins utilized as the resin coating may have a glass transition temperature of from about 30° C. to about 80° C., in embodiments from about 35° C. to about 70° C. In further embodiments, the resins utilized as the resin coating may have a melt viscosity of from about 10 to about 1,000,000 Pa*S at about 130° C., in embodiments from about 20 to about 100,000 Pa*S.

### Crystalline Polyester Resin

The crystalline resins, which are available from a number of sources, can be prepared by a polycondensation process by reacting an organic diol, and an organic diacid in the presence of a polycondensation catalyst. Generally, a stoichiometric equimolar ratio of organic diol and organic diacid is utilized, however, in some instances, wherein the boiling point of the organic diol is from about 180° C. to about 230° C., an excess amount of diol can be utilized and removed during the polycondensation process. The amount of catalyst utilized varies, and can be selected in an amount, for example, of from about 0.01 to about 1 mole percent of the resin. Additionally, in place of the organic diacid, an organic diester can also be selected, and where an alcohol byproduct is generated.

Examples of organic diols include aliphatic diols with from about 2 to about 36 carbon atoms, such as 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, and the like; alkali sulfo-aliphatic diols such as sodio 2-sulfo-1,2-ethanediol, lithio 2-sulfo-1,2-ethanediol, potassio 2-sulfo-1,2-ethanediol, sodio 2-sulfo-1,3-propanediol, lithio 2-sulfo-1,3-propanediol, potassio 2-sulfo-1,3-propanediol, mixture thereof, and the like. The aliphatic diol is, for example, selected in an amount of from about 45 to about 50 mole percent of the resin, and the alkali sulfo-aliphatic diol can be selected in an amount of from about 1 to about 10 mole percent of the resin.

Examples of organic diacids or diesters selected for the preparation of the crystalline polyester resins include oxalic acid, succinic acid, glutaric acid, adipic acid, suberic acid, azelaic acid, sebacic acid, phthalic acid, isophthalic acid, terephthalic acid, napthalene-2,6-dicarboxylic acid, naphthalene-2,7-dicarboxylic acid, cyclohexane dicarboxylic acid, malonic acid and mesaconic acid, a diester or anhydride thereof; and an alkali sulfo-organic diacid such as the sodio, lithio or potassium salt of dimethyl-5-sulfo-isophthalate, dialkyl-5-sulfo-isophthalate-4-sulfo-1,8-naphthalic anhydride, 4-sulfo-phthalic acid, dimethyl-4-sulfo-phthalate, dialkyl-4-sulfo-phthalate, 4-sulfophenyl-3,5-dicarbomethoxybenzene, 6-sulfo-2-naphthyl-3,5-dicarbometh-oxybenzene, sulfo-terephthalic acid, dimethyl-sulfo-terephthalate, 5-sulfo-isophthalic acid, dialkyl-sulfo-terephthalate, sulfoethanediol, 2-sulfopropanediol, 2-sulfobutanediol, 3-sulfopentanediol, 2-sulfohexanediol, 3-sulfo-2-methyl-pentanediol, 2-sulfo-3,3-dimethylpentanediol, sulfo-p-hydroxybenzoic acid, N,N-bis(2-hydroxyethyl)-2-amino ethane sulfonate, or mixtures thereof. The organic diacid is selected in an amount of, for example, from about 40 to about 50 mole percent of the resin, and the alkali sulfoaliphatic diacid can be selected in an amount of from about 1 to about 10 mole percent of the resin. There can be selected for the third latex branched amorphous resin an alkali sulfonated polyester resin. Examples of suitable alkali sulfonated polyester resins include, the metal or alkali salts of copoly(ethylene-terephthalate)-copoly-(ethylene-5-sulfo-isophthalate), copoly(propylene-terephthalate)-copoly(propylene-5-sulfo-isophthalate), copoly(diethylene-terephthalate)-copoly(diethylene-5-sulfo-isophthalate), copoly(propylene-diethylene-terephthalate)-copoly(propylene-diethylene-5-sulfo-isophthalate), copoly(propylene-butylene-terephthalate)-copoly(propylene-butylene-5-sulfo-isophthalate), copoly-(propoxylated bisphenol-A-fumarate)-copoly(propoxylated bisphenol-A-5-sulfo-isophthalate), copoly(ethoxylated bisphenol-A-fumarate)-copoly(ethoxylated bisphenol-A-5-sulfo-isophthalate), and copoly(ethoxylated bisphenol-A-maleate)-copoly(ethoxylated bisphenol-A-5-sulfo-isophthalate), and wherein the alkali metal is, for example, a sodium, lithium or potassium ion.

Examples of crystalline based polyester resins include alkali copoly(5-sulfo-isophthaloyl)-co-poly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(octylene-adipate), alkali copoly(5-sulfo-isophthaloyl)-copoly(ethylene-adipate), alkali copoly(5-sulfo-isophthaloyl)-copoly (propylene-adipate), alkali copoly(5-sulfo-isophthaloyl)-co-poly(butylene-adipate), alkali copoly(5-sulfo-isophthaloyl)-copoly(pentylene-adipate), alkali copoly(5-sulfo-isopthaloyl)-copoly(hexylene-adipate), alkali copoly(5-sulfo-isophthaloyl)-copoly(octylene-adipate), alkali copoly(5-sulfo-isophthaloyl)-copoly(ethylene-succinate), alkali copoly(5-sulfo-isophthaloyl-copoly(butylene-succinate), alkali copoly(5-sulfo-isophthaloyl)-copoly(hexylene-succinate), alkali copoly(5-sulfo-isophthaloyl)-copoly(octylene-succinate), alkali copoly(5-sulfo-isophthaloyl)-copoly(ethylene-sebacate), alkali copoly(5-sulfo-isophthaloyl)-copoly(propylene-sebacate), alkali copoly(5-sulfo-isophthaloyl)-copoly(butylene-sebacate), alkali copoly(5-sulfo-isophthaloyl)-copoly(pentylene-sebacate), alkali copoly(5-sulfo-isophthaloyl)-copoly(hexylene-sebacate), alkali copoly(5-sulfo-isophthaloyl)-copoly(octylene-sebacate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), poly(octylene-adipate); and wherein alkali is a metal of sodium, lithium or potassium, and the like. In embodiments, the alkali metal is lithium.

The crystalline resin may be present, for example, in an amount of from about 5 to about 50 percent by weight of the toner components, in embodiments from about 10 to about 35 percent by weight of the toner components. The crystalline resin can possess various melting points of, for example, from about 30° C. to about 120° C., in embodiments from about 50° C. to about 90° C. The crystalline resin may have a number average molecular weight (Mn), as measured by gel permeation chromatography (GPC) of, for example, from about 1,000 to about 50,000, in embodiments from about 2,000 to about 25,000, and a weight average molecular weight (Mw) of, for example, from about 2,000 to about 100,000, in embodiments from about 3,000 to about 80,000, as determined by Gel Permeation Chromatography using polystyrene standards. The molecular weight distribution (Mw/Mn) of the crystalline resin may be, for example, from about 2 to about 6, in embodiments from about 3 to about 4.

### Hybrid Resin Toners

In embodiments, toner particles may comprise hybrid styrene-acrylate polyester with beta-carboxyethyl acrylate (also named as 3-(prop-2-enoyloxy)propanoic acid, or b-CEA or β-CEA) styrene-acrylate shell latex for improved particle formation and morphology. In an exemplary embodiment, 1.5 pph β-CEA styrene-acrylate latex may be used in such hybrid toners with styrene-acrylate shells. Such toners may have a core and a shell, wherein the core comprises a first resin comprising a styrene acrylate copolymer, and an amorphous resin, and the shell comprises a second resin comprising in an amount of from about 0.05 pph to about 2.5 pph by weight of the shell. The second resin may also comprise a styrene acrylate copolymer.

Such toners may be prepared by emulsion aggregation (EA). The small amounts of β-CEA (i.e., from about 0.05 pph to about 2.5 pph) present in the shell is beneficial for the EA process helping to improve the resin flow in the toner coalescence. Without the presence of β-CEA in the shell may result in poor toner particle properties with respect to size, the geometric standard deviation (GSD), fines, and coarse. With more than 2.5 pph of β-CEA present in the shell may cause the coalescence process to be too slow for the shell latex resulting in poor toner particle properties, such as a rough and incomplete shell that does not encompass the entire toner particle.

In embodiments, the amount of β-CEA present in the second resin in the shell may be from about 1 pph to about 2 pph, from about 0.3 pph to about 1.7 pph, or from about 0.5 pph to about 1.5 pph by weight of the second resin.

In embodiments, the amount of β-CEA present in the first resin in the core may be from about 0 pph to about 10 pph of β-CEA by weight of the first resin, such as from about 3 pph to about 10 pph, from about 3 pph to about 8 pph, or from about 3 pph to about 5 pph by weight of the first resin. In one embodiment, no β-CEA is present in the first resin. The first resin may contain a lower amount of β-CEA, such as less than 3 pph by weight of the first resin, or having the same β-CEA content as in the second resin, or a higher β-CEA amount than that in the second resin. However, to avoid over spherodization of the core, it may not be desirable to improve the flow of the core latex in the core by lowering the amount of β-CEA present in the core. For example if the Tg and molecular weight of the first resin in the core is relatively low, lower β-CEA in the core may result in overspherodization of the core of the toner for embodiments where a non-spherical toner is desired. The term “spherodization” means that the overall toner particle circularity increases. It is desired that the circularity can be controlled, in embodiments within the range of about 0.93 and about 0.99. However, if the coalescence of the core is too rapid, then the circularity of the toner particle may not be easily controlled as it grows too rapidly. In a production scale, it is desirable that the target circularity of the toner particle to be reached within the time frame of from about 90 minutes to about 4 hours. If the coalescence process is faster than 90 minutes it may be difficult to monitor and stop the circularity increase. On the other hand, if the coalescence process is longer than 4 hours, then toner production throughput may suffer.

In embodiments, the amount of β-CEA in the first resin is higher than the amount of β-CEA in the second resin. In embodiments, the amount of β-CEA in the first resin is lower than the amount of β-CEA in the second resin.

The first and second resins may be the same or different. Illustrative examples of specific polymers for the first and second resins include, for example, poly(styrene-alkyl acrylate), poly(styrene-alkyl methacrylate), poly(styrene-alkyl acrylate-acrylic acid), poly(styrene-alkyl methacrylate-acrylic acid), poly(alkyl methacrylate-alkyl acrylate), poly(alkyl methacrylate-aryl acrylate), poly(aryl methacrylate-alkyl acrylate), poly(alkyl methacrylate-acrylic acid), poly(styrene-alkyl acrylate-acrylonitrile-acrylic acid), poly(alkyl acrylate-acrylonitrile-acrylic acid), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene), poly(styrene-propyl acrylate), poly(styrene-butyl acrylate), poly(styrene-butyl acrylate-acrylic acid), poly(styrene-butyl acrylate-methacrylic acid), poly(styrene-butyl acrylate-acrylonitrile), poly(styrene-butyl acrylate-acrylonitrile-acrylic acid), poly(styrene-1,3-diene), poly(styrene-1,3-diene-acrylic acid), poly (styrene-1,3-diene-acrylonitrile-acrylic acid), poly(styrene-butadiene), poly(methylstyrene-butadiene), poly (styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), poly(styrene-butyl acrylate-acrylonitrile-acrylic acid), poly(styrene-butadiene), poly(styrene-isoprene), poly(styrene-butyl methacrylate), poly(styrene-butyl methacrylate-acrylic acid), poly(butyl methacrylate-butyl acrylate), poly(butyl methacrylate-acrylic acid), poly(acrylonitrile-butyl acrylate-acrylic acid), and mixtures thereof. The alkyl group in the aforementioned polymers may be any alkyl group, and in particular may be a C₁-C₁₂ alkyl group, for example including methyl, ethyl, propyl and butyl. As the aryl group, any aryl group known in the art may be used.

In embodiments, the first resin and the second resin may be, independently, styrene-alkyl acrylate, more particularly a styrene-butyl acrylate polymer such as a styrene-butyl acrylate polymer.

In embodiments, the first resin and the second resin each include a styrene monomer and an acrylic monomer. In embodiments, the first resin further comprises at least one cross-linker. In embodiments, the second resin further comprises at least one cross-linker.

As used herein, the term “styrene monomer” refers to styrene per se, as well as styrene containing one or more substitutions, such as 3-chlorostyrene, 2,5-dichlorostyrene, 4-bromostyrene, 4-tert-butylstyrene, 4-methoxystyrene and the like.

As used herein, the term “acrylic acid monomer” refers to acrylic acid, methacrylic acid, and β-CEA. As used herein, the term “acrylic ester monomer” refers to esters of acrylic acid and methacrylic acid. Acrylic ester monomers include, but are not limited to, butyl acrylate, butyl methacrylate, propyl acrylate, propyl methacrylate, ethyl acrylate, ethyl methacrylate, methyl acrylate and methyl methacrylate. In certain embodiments, the acrylic ester monomer is n-butyl acrylate.

In embodiments, the styrene monomer is present in the core in an amount of from about 30 to about 90, or from about 70 to about 90 weight percent by weight of the core resin.

In embodiments, the acrylic ester monomer is present in the core in an amount of from about 10 to about 70, or from about 10 to about 30 weight percent by weight of the core resin.

In embodiments, the styrene monomer is present in the shell in an amount of from about 30 to about 90, or from about 70 to about 90 weight percent by weight of the shell.

In embodiments, the acrylic ester monomer is present in the shell in an amount of from about 10 to about 70, or from about 10 to about 30 weight percent by weight of the shell.

In embodiments, the first resin includes styrene and n-butyl acrylate.

In embodiments, the second resin includes styrene and n-butyl acrylate.

The first resin may have a mean particle size of from about 100 nm to about 250 nm, from about 100 nm to about 140 nm, from about 140 nm to about 200 nm, or from about 140 to about 250 nm.

The second resin may have a mean particle size of from about 100 nm to about 250 nm, from about 100 nm to about 140 nm, from about 140 nm to about 200 nm, or from about 140 to about 250 nm.

### Branched Ester Wax

In embodiments, the EA toners disclosed herein comprise a branched ester wax. In embodiments, a branched wax ester is the condensation product of a branched polyol structure and a C₆-C₂₂ fatty acid. Branched polyol structures include, without limitation, pentaerythritol, dipentaerythritol, glycerol, pentaerythritol, and trimethylolpropane as well as their dimers, trimers and higher oligomers such as but not limited to diglycerol, triglycerol, dipentaerythritol, tripentaerythritol, di(trimethylolpropane), and tri(trimethylolpropane).]

In embodiments, the branched ester wax comprises a pentaerythritol ester wax or a dipentaerythritol ester wax. In embodiments, the branched ester wax is represented by formula I or I:

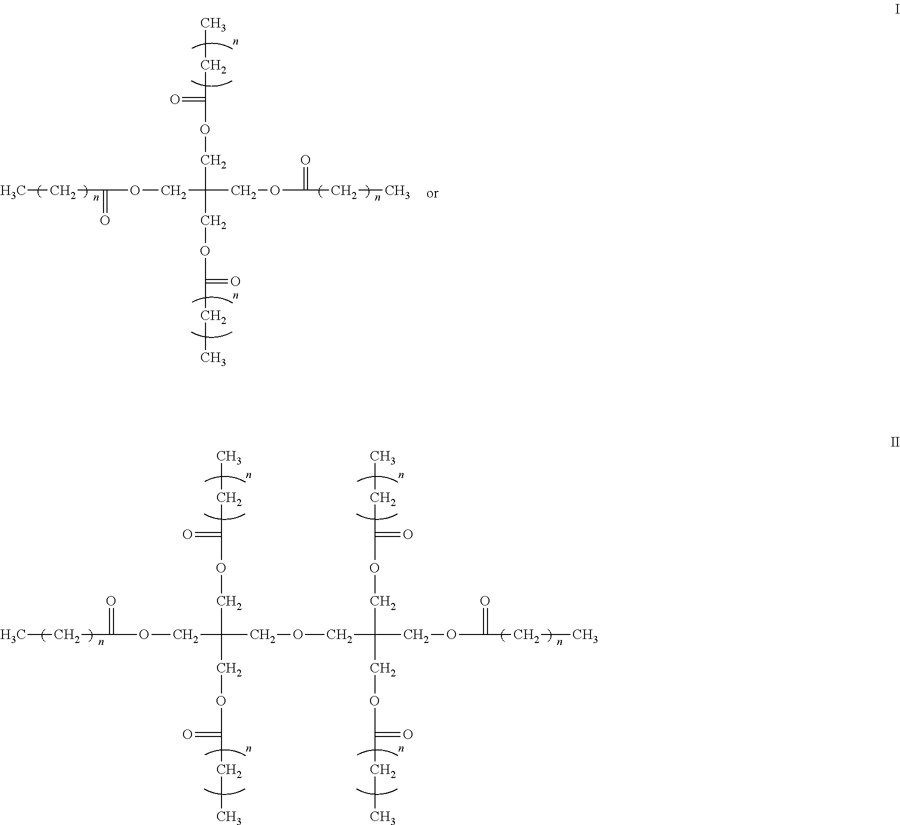

wherein each n in formula I and II are independently an integer from 4 to 20.

In embodiments, the branched ester wax comprises from about 1 percent to about 20 percent by weight of the core.

### Coagulants

In some embodiments, toner compositions disclosed herein may comprise a coagulant. In some embodiments, the coagulants used in the present process comprise aluminum sulfate, poly metal halides, such as polyaluminum chloride (PAC), or polyaluminum sulfo silicate (PASS). For example, the coagulants provide a final toner having a metal content of, for example, about 400 to about 10,000 parts per million. In another feature, the coagulant comprises a poly aluminum chloride providing a final toner having an aluminum content of about 400 to about 10,000 parts per million.

### Shell

In embodiments, the EA toner particles may further comprise a shell, the shell being disposed about the core of the toner particle. The shell may comprise a polyester. The shell may be added to the core

### Toner Compositions

In embodiments there are provided toner compositions comprising an emulsion aggregation (EA) toner particle for use in a xerographic apparatus comprising an oiled fusing system, the EA toner particle comprising a core comprising a resin, a branched ester wax having substantially no solubility in fuser oil, a coagulant and an optional colorant and a shell disposed about the core. Such compositions comprise surface additives disposed on the surface of the EA toner particle.

### Surface Additives

In embodiments, the toner compositions may comprise surface additives comprise a charge control agent and flow aid additives as desired. For example, the toner can include positive or negative charge control agents in any desired or effective amount, in one embodiment in an amount of at least about 0.1 percent by weight of the toner, and in another embodiment at least about 1 percent by weight of the toner, and in one embodiment no more than about 10 percent by weight of the toner, and in another embodiment no more than about 3 percent by weight of the toner. Examples of suitable charge control agents include, but are not limited to, quaternary ammonium compounds inclusive of alkyl pyridinium halides; bisulfates; alkyl pyridinium compounds, including those disclosed in U.S. Pat. No. 4,298,672, the disclosure of which is totally incorporated herein by reference; organic sulfate and sulfonate compositions, including those disclosed in U.S. Pat. No. 4,338,390, the disclosure of which is totally incorporated herein by reference; cetyl pyridinium tetrafluoroborates; distearyl dimethyl ammonium methyl sulfate; aluminum salts such as BONTRON E84™ or E88™ (Hodogaya Chemical); and the like, as well as mixtures thereof. Such charge control agents can be applied simultaneously with the shell resin described above or after application of the shell resin.

There can also be blended with the toner particles other external additive particles, including flow aid additives, which can be present on the surfaces of the toner particles. Examples of these additives include, but are not limited to, other metal oxides, such as tin oxide; colloidal and amorphous silicas, such as AEROSIL®, metal salts and metal salts of fatty acids including zinc stearate, cerium oxides, and the like, as well as mixtures thereof. Each of these additional external additives can be present in any desired or effective amount, in one embodiment at least about 0.1 percent by weight of the toner, and in another embodiment at least about 0.25 percent by weight of the toner, and in one embodiment no more than about 5 percent by weight of the toner, and in another embodiment no more than about 3 percent by weight of the toner. Suitable additives include, but are not limited to, those disclosed in U.S. Pat. Nos. 3,590,000, 3,800,588, and 6,214,507, the disclosures of each of which are totally incorporated herein by reference. Again, these additives can be applied simultaneously with the shell resin described above or after application of the shell resin.

The toner particles of the present embodiments exhibits a dielectric loss of about 10 to about 45, from about 5 to about 35, or from about 5 to about 60. The toner particles of the present embodiments exhibits a gloss from about 10 ggu to about 60 ggu, from about 20 ggu to about 70 ggu, or from about 30 ggu to about 70 ggu on plain paper The toner particles of the present embodiments have an average particle size of from about 4 μm to about 10 μm, from about 4 μm to about 7 μm, or from about 4 μm to about 20 μm The toner particles of the present embodiments have an average circularity of from about 0.93 to about 0.99, from about 0.96 to about 0.98, or from about 0.95 to about 0.99. The toner particles of the present embodiments have a shape factor of from about 120 to about 140, from about 110 to about 130, or from about 105 to about 150. The toner particles of the present embodiments have a volume geometric standard deviation for (D84/D50) in the range of from about 1.15 to about 1.25, from about 1.15 to about 1.30, or from about 1.20 to about 1.25. The toner particles of the present embodiments have a number geometric standard deviation for (D16/D50) in the range of from about 1.15 to about 1.25, from about 1.15 to about 1.30, or from about 1.20 to about 1.25.

### Surfactants

In some embodiments, toner particles disclosed herein may be formed in the presence of surfactants. For example, surfactants may be present in a range of from about 0.01 to about 20, or about 0.1 to about 15 weight percent of the reaction mixture. Suitable surfactants include, for example, nonionic surfactants such as dialkylphenoxypoly-(ethyleneoxy) ethanol, available from Rhone-Poulenc as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™. In some embodiments, an effective concentration of the nonionic surfactant may be in a range of from about 0.01 percent to about 10 percent by weight, or about 0.1 percent to about 5 percent by weight of the reaction mixture.

Suitable anionic surfactants may include, without limitation sodium dodecylsulfate (SDS), sodium dodecylbenzene sulfonate, sodium dodecylnaphthalene sulfate, dialkyl benzenealkyl, sulfates and sulfonates, adipic acid, available from Aldrich, NEOGEN R™, NEOGEN SC™, available from Kao, Dowfax 2A1 (hexa decyldiphenyloxide disulfonate) and the like, among others. For example, an effective concentration of the anionic surfactant generally employed is, for example, about 0.01 percent to about 10 percent by weight, or about 0.1 percent to about 5 percent by weight of the reaction mixture

In some embodiments, anionic surfactants may be used in conjunction with bases to modulate the pH and hence ionize the aggregate particles thereby providing stability and preventing the aggregates from growing in size. Such bases can be selected from sodium hydroxide, potassium hydroxide, ammonium hydroxide, cesium hydroxide and the like, among others.

Examples of additional surfactants, which may be added optionally to the aggregate suspension prior to or during the coalescence to, for example, prevent the aggregates from growing in size, or for stabilizing the aggregate size, with increasing temperature can be selected from anionic surfactants such as sodium dodecylbenzene sulfonate, sodium dodecylnaphthalene sulfate, dialkyl benzenealkyl, sulfates and sulfonates, adipic acid, available from Aldrich, NEOGEN R™, NEOGEN SC™ available from Kao, and the like, among others. These surfactants can also be selected from nonionic surfactants such as polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxypoly(ethyleneoxy) ethanol, available from Rhone-Poulenac as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™ For example, an effective amount of the anionic or nonionic surfactant generally employed as an aggregate size stabilization agent is, for example, about 0.01 percent to about 10 percent or about 0.1 percent to about 5 percent, by weight of the reaction mixture.

In some embodiments acids that may be utilized in conjunction with surfactants to modulate pH. Acid may include, for example, nitric acid, sulfuric acid, hydrochloric acid, acetic acid, citric acid, trifluoroacetic acid, succinic acid, salicylic acid and the like, and which acids are in embodiments utilized in a diluted form in the range of about 0.5 to about 10 weight percent by weight of water or in the range of about 0.7 to about 5 weight percent by weight of water.

### Pigments and Colorants

Toner compositions disclosed herein may further comprise a pigment or colorant. Colorants or pigments as used herein include pigment, dye, mixtures of pigment and dye, mixtures of pigments, mixtures of dyes, and the like. For simplicity, the term “colorant” as used herein is meant to encompass such colorants, dyes, pigments, and mixtures, unless specified as a particular pigment or other colorant component. In embodiments, the colorant comprises a pigment, a dye, mixtures thereof, carbon black, magnetite, black, cyan, magenta, yellow, red, green, blue, brown, mixtures thereof, in an amount of about 1% to about 25% by weight based upon the total weight of the composition. It is to be understood that other useful colorants will become readily apparent to one of skill in the art based on the present disclosures.

In general, useful colorants include, but are not limited to, Paliogen Violet 5100 and 5890 (BASF), Normandy Magenta RD-2400 (Paul Uhlrich), Permanent Violet VT2645 (Paul Uhlrich), Heliogen Green L8730 (BASF), Argyle Green XP-111-S(Paul Uhlrich), Brilliant Green Toner GR 0991 (Paul Uhlrich), Lithol Scarlet D3700 (BASF), Toluidine Red (Aldrich), Scarlet for Thermoplast NSD Red (Aldrich), Lithol Rubine Toner (Paul Uhlrich), Lithol Scarlet 4440, NBD 3700 (BASF), Bon Red C (Dominion Color), Royal Brilliant Red RD-8192 (Paul Uhlrich), Oracet Pink RF (Ciba Geigy), Paliogen Red 3340 and 3871 K (BASF), Lithol Fast Scarlet L4300 (BASF), Heliogen Blue D6840, D7080, K7090, K6910 and L7020 (BASF), Sudan Blue OS (BASF), Neopen Blue FF4012 (BASF), PV Fast Blue B2G01 (American Hoechst), Irgalite Blue BCA (Ciba Geigy), Paliogen Blue 6470 (BASF), Sudan II, III and IV (Matheson, Coleman, Bell), Sudan Orange (Aldrich), Sudan Orange 220 (BASF), Paliogen Orange 3040 (BASF), Ortho Orange OR 2673 (Paul Uhlrich), Paliogen Yellow 152 and 1560 (BASF), Lithol Fast Yellow 0991 K (BASF), Paliotol Yellow 1840 (BASF), Novaperm Yellow FGL (Hoechst), Permanerit Yellow YE 0305 (Paul Uhlrich), Lumogen Yellow D0790 (BASF), Suco-Gelb 1250 (BASF), Suco-Yellow D1355 (BASF), Suco Fast Yellow D1165, D1355 and D1351 (BASF), Hostaperm Pink E (Hoechst), Fanal Pink D4830 (BASF), Cinquasia Magenta (DuPont), Paliogen Black L9984 9BASF), Pigment Black K801 (BASF) and particularly carbon blacks such as REGAL 330□ (Cabot), Carbon Black 5250 and 5750 (Columbian Chemicals), and the like or mixtures thereof.

Additional useful colorants include pigments in water based dispersions such as those commercially available from Sun Chemical, for example SUNSPERSE BHD 6011X (Blue 15 Type), SUNSPERSE BHD 9312X (Pigment Blue 15 74160), SUNSPERSE BHD 6000X (Pigment Blue 15:3 74160), SUNSPERSE GHD 9600X and GHD 6004X (Pigment Green 7 74260), SUNSPERSE QHD 6040X (Pigment Red 122 73915), SUNSPERSE RHD 9668X (Pigment Red 185 12516), SUNSPERSE RHD 9365X and 9504X (Pigment Red 57 15850:1, SUNSPERSE YHD 6005X (Pigment Yellow 83 21108), FLEXIVERSE YFD 4249 (Pigment Yellow 17 21105), SUNSPERSE YHD 6020X and 6045X (Pigment Yellow 74 11741), SUNSPERSE YHD 600X and 9604X (Pigment Yellow 14 21095), FLEXIVERSE LFD 4343 and LFD 9736 (Pigment Black 7 77226) and the like or mixtures thereof. Other useful water based colorant dispersions include those commercially available from Clariant, for example, HOSTAFINE Yellow GR, HOSTAFINE Black T and Black TS, HOSTAFINE Blue B2G, HOSTAFINE Rubine F6B and magenta dry pigment such as Toner Magenta 6BVP2213 and Toner Magenta E02 which can be dispersed in water and/or surfactant prior to use.

Other useful colorants include, for example, magnetites, such as Mobay magnetites M08029, M08960; Columbian magnetites, MAPICO BLACKS and surface treated magnetites; Pfizer magnetites CB4799, CB5300, CB5600, MCX6369; Bayer magnetites, BAYFERROX 8600, 8610; Northern Pigments magnetites, NP-604, NP-608; Magnox magnetites TMB-100 or TMB-104; and the like or mixtures thereof. Specific additional examples of pigments include phthalocyanine HELIOGEN BLUE L6900, D6840, D7080, D7020, PYLAM OIL BLUE, PYLAM OIL YELLOW, PIGMENT BLUE 1 available from Paul Uhlrich & Company, Inc., PIGMENT VIOLET 1, PIGMENT RED 48, LEMON CHROME YELLOW DCC 1026, E.D. TOLUIDINE RED and BON RED C available from Dominion Color Corporation, Ltd., Toronto, Ontario, NOVAPERM YELLOW FGL, HOSTAPERM PINK E from Hoechst, and CINQUASIA MAGENTA available from E.I. DuPont de Nemours & Company, and the like. Examples of magentas include, for example, 2,9-dimethyl substituted quinacridone and anthraquinone dye identified in the Color Index as CI 60710, CI Dispersed Red 15, diazo dye identified in the Color Index as CI 26050, CI Solvent Red 19, and the like or mixtures thereof. Illustrative examples of cyans include copper tetra(octadecyl sulfonamide) phthalocyanine, x-copper phthalocyanine pigment listed in the Color Index as CI74160, CI Pigment Blue, and Anthrathrene Blue identified in the Color Index as DI 69810, Special Blue X-2137, and the like or mixtures thereof. Illustrative examples of yellows that may be selected include diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,4-dimethoxy acetoacetanilide, and Permanent Yellow FGL. Colored magnetites, such as mixtures of MAPICOBLACK and cyan components may also be selected as pigments.

In embodiments, there are provided methods of printing comprising providing a toner composition in a toner cartridge, the toner composition comprising an emulsion aggregation (EA) toner particle for use in a xerographic apparatus comprising an oiled fusing system, the EA toner particle comprising a core comprising a resin, a branched ester wax having substantially no solubility in fuser oil, a coagulant, and an optional colorant, and a shell disposed about the core, and surface additives disposed on the surface of the EA toner particle.

In embodiments, methods further comprise printing on a substrate with the toner cartridge equipped in the xerographic apparatus comprising the oiled fusing system. In some such embodiments, printing may comprise multi-pass image on image (IOI) printing.

The branched ester wax EA toners disclosed herein may allow lower oil levels “less oil on fuser” which will improve multi-pass prints (facilitating specialty toners-white, gold, silver, clear) with good toner to toner adhesion as well as extended fuser roll life.

In multi-pass Image on Image (IOI) print mode, a toner layer is developed on top of a fused CMYK patch. The oil layer on top of the fused CMYK patch prevents the overlying toner layer (which may be a clear layer) from adequately fixed to the patch below. As result, specialty toners can be easily scratched off and is unacceptable for customer. However, in accordance with embodiments herein, lower fuser oil levels are accessible with branched wax ester toners permitting use of less or a different oil to get acceptable toner to toner adhesion for multi-pass printing. This would be an immense improvement from existing waxless toner systems because in such waxless systems fuser roll life suffers significantly (2 to 3 times reduction in life). The small amount of branched ester wax in the present EA toner, will improve fuser roll life, while also providing better toner to toner adhesion.

The following Examples are being submitted to illustrate embodiments of the present disclosure. These Examples are intended to be illustrative only and are not intended to limit the scope of the present disclosure. Also, parts and percentages are by weight unless otherwise indicated. As used herein, “room temperature” refers to a temperature of from about 20° C. to about 25° C.

### EXAMPLES

### Example 1

This example describes the characterization of an EA toner comprising a branched wax ester in accordance with embodiments herein.

An experimental EA toner particle was made on a 2 L reactor scale with NOF 240 dipentaerythritol branched ester wax (NOF Corporation, Japan)

Differential Scanning calorimetry (DSC) was conducted by the following procedure: Approximately 10 mg of sample was weighed into a Tzero standard pan and analyzed using a TA Instruments Q2000 (S/N 2622) by the following temperature program:

0-180° C. @ 10° C./min

180-0° C. @ 10° C./min

0-10° C. @ 10° C./min

DSC analysis indicated 9% of the branched ester wax was incorporated into the toner particle. See FIGS. 1a and 1b for DSC of wax analysis. Table A below shows DSC results for:

| | ΔH (J/g) 2^{nd} heat | |
|---|---|---|
| Sample ID | (integrated 59-86 C.) | % wax |
| Branched Ester | 100.3 | — |
| Wax | | |
| EA toner with | 9.173 | 9 |
| branched ester | | |
| wax | | |
| EA toner without | 0.5275 | 0 |
| wax | | |
| Hydrocarbon wax | 206.2 (integrated 60-100 C.) | — |
| EA toner with | 19.40 (integrated 60-100 C.) | 9 vs hydrocarbon |
| hydrocarbon wax | | wax |

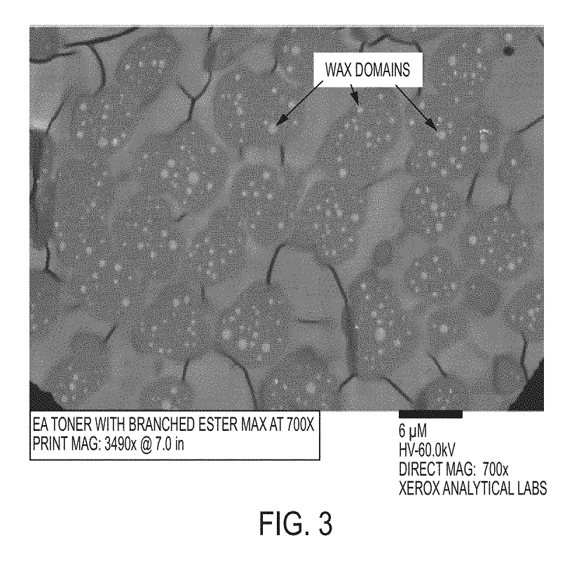

Transmission electron microscopy (TEM) cross-section analysis of the toner clearly indicated wax domains in toner core as indicated in FIG. 3.

### Example 2

This example describes the viability of various waxes both linear and branched ester waxes in EA toner particles with fuser oil.

Toner particles were prepared containing one of (1) branched ester wax, (2) no wax and (3) linear wax. Samples were shaken in glass vials with three different fuser oils i.e., Fuser Fluid 2, Fuser Agent 2 and Fuser Shield. The glass vials having the toner and oil were then kept in oven at 100° C. for about four hours and were then cooled to room temperature. Toner having linear wax caused all three oils to form an undesirable gel. Toner with no wax or branched ester wax did not cause oil gelation.

This Example indicates that toners with branched ester waxes with poor solubility in fuser oil can be employed in a fusing system with a branched ester wax toner. Because the branched waxes have poor solubility in fuser oil, very little wax would accumulate in the oil sump from the fuser roll. The small amount of wax that does would not lead to gelation as is observed with linear waxes. Branched ester waxes would instead phase separate and precipitate out in sump. Based on the amount of wax collecting in the sump, it can be readily filtered out, in sharp contrast to the homogenous gel formed with linear waxes.

What is claimed is:

1. An emulsion aggregation (EA) toner particle for use in a xerographic apparatus comprising an oiled fusing system, the EA toner particle comprising:
a core comprising:
a resin;
a branched ester wax having substantially no solubility in fuser oil;
a coagulant; and
an optional colorant.

2. The EA toner particle of claim 1, wherein the resin comprises a polyester, a styrene-acrylate, or combinations thereof.

3. The EA toner particle of claim 2, wherein the polyester is amorphous, crystalline, or combinations thereof.

4. The EA toner particle of claim 1, wherein the resin comprises a high molecular weight amorphous polyester in a range from about 60,000 daltons to about 80000 daltons, a low molecular weight polyester in a range from about 16,000 daltons to about 20,000 daltons, and a crystalline polyester.

5. The EA toner particle of claim 1, wherein the resin comprises from about 80% to about 99% by weight of the core.

6. The EA toner particle of claim 1, wherein the branched ester wax comprises a pentaerythritol ester wax or a dipentaerythritol ester wax.

7. The EA toner particle of claim 1, wherein the branched ester wax is represented by formula I or I: 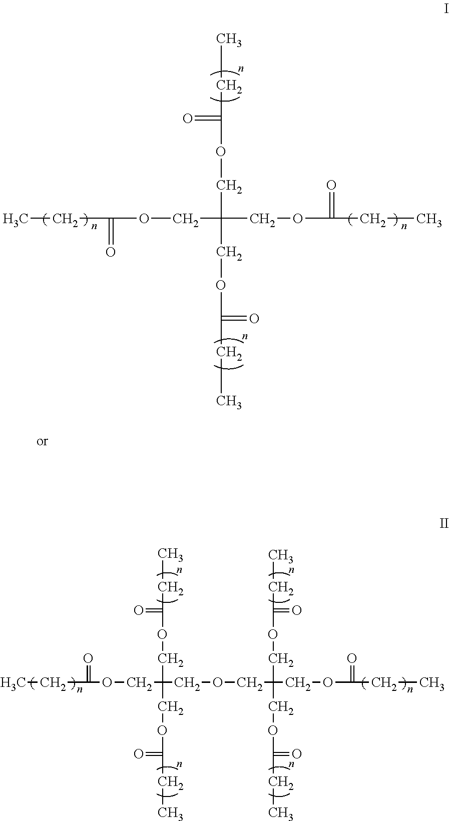
wherein each n in formula I and II are independently an integer from 4 to 20.

8. The EA toner particle of claim 1, wherein the branched ester wax comprises from about 1% to about 20% by weight of the core.

9. The EA toner particle of claim 1, further comprising a shell.

10. The EA toner particle of claim 9, wherein the shell comprises a polyester.

11. A toner composition comprising:
an emulsion aggregation (EA) toner particle for use in a xerographic apparatus comprising an oiled fusing system, the EA toner particle comprising:
a core comprising:
a resin;
a branched ester wax having substantially no solubility in fuser oil;
a coagulant; and
an optional colorant; and
a shell; and
surface additives disposed on the surface of the EA toner particle.

12. The toner composition of claim 11, wherein the resin comprises a high molecular weight amorphous polyester, a low molecular weight polyester, and a crystalline polyester.

13. The toner composition of claim 11, wherein the branched ester wax is represented by formula I or I: 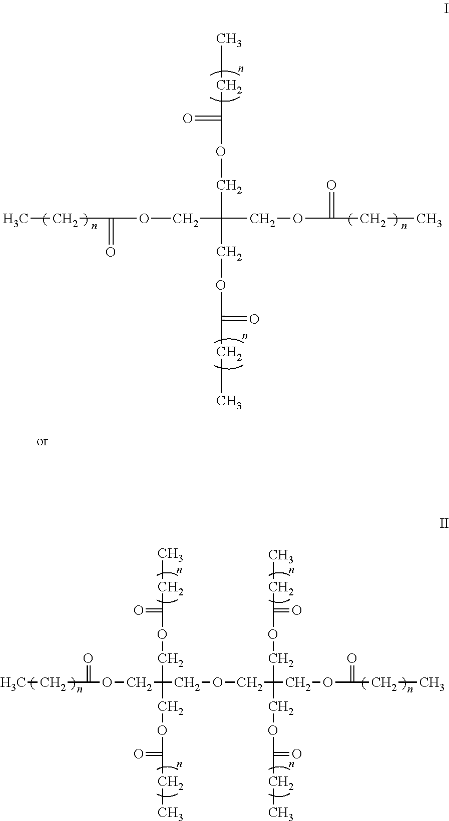
wherein each n in formula I and II are independently an integer from 4 to 20.

14. The toner composition of claim 11, wherein the surface additives comprise a charge control agent and flow aid additives.

15. A method of printing comprising:
providing a toner composition in a toner cartridge, the toner composition comprising:
an emulsion aggregation (EA) toner particle for use in a xerographic apparatus comprising an oiled fusing system, the EA toner particle comprising:
a core comprising:
a resin;
a branched ester wax having substantially no solubility in fuser oil;
a coagulant; and
an optional colorant; and
a shell; and
surface additives disposed on the surface of the EA toner particle.

16. The method of claim 15, wherein the resin comprises a high molecular weight amorphous polyester, a low molecular weight polyester, and a crystalline polyester.

17. The method of claim 15, wherein the branched ester wax is represented by formula I or I: 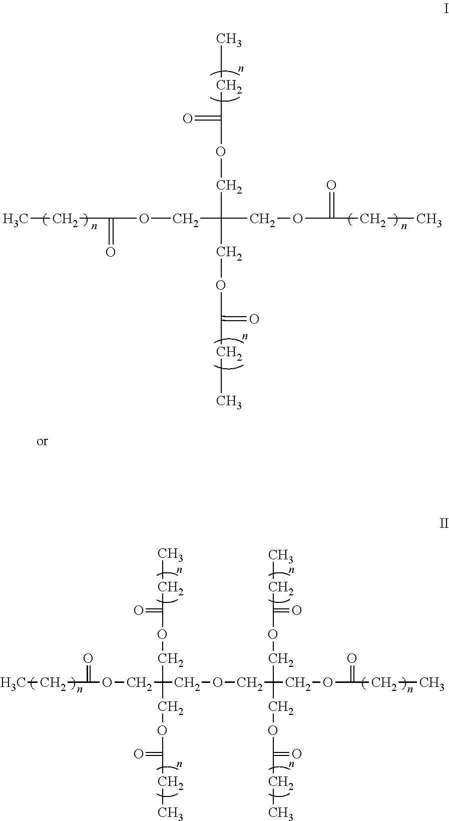
wherein each n in formula I and II are independently an integer from 4 to 20.

18. The method of claim 15, wherein the surface additives comprise a charge control agent and flow aid additives.

19. The method of claim 15, further comprising printing on a substrate with the toner cartridge equipped in the xerographic apparatus comprising the oiled fusing system.

20. The method of claim 19, wherein printing comprises multipass image on image (IOI) printing.
